(19) United States
(12) Patent Application Publication
(10) Pub. No.: US 2017/0200368 A1
(43) Pub. Date: Jul. 13, 2017

(54) METHOD AND SYSTEM FOR VEHICLE CONGESTION PRICING

(71) Applicants: Scott E. LE VINE, Franklin Lakes, NJ (US); John W. POLAK, Franklin Lakes, NJ (US)

(72) Inventors: Scott E. LE VINE, Franklin Lakes, NJ (US); John W. POLAK, Franklin Lakes, NJ (US)

(21) Appl. No.: 15/402,037

(22) Filed: Jan. 9, 2017

Related U.S. Application Data
(60) Provisional application No. 62/275,830, filed on Jan. 7, 2016.

(51) Int. Cl. G08G 1/16; G06K 9/00; G05D 1/00; G05D 1/02; G06Q 20/10; G06Q 20/22

(52) U.S. Cl. CPC G08G 1/161; G06Q 20/10; G06Q 20/223; G05D 1/0088; G08G 1/166; G05D 1/0231; G05D 1/0278; G05D 1/027; G05D 1/0255; G06K 9/00892; G05D 2201/0213; G05D 1/0212; B60W 30/12

(57) ABSTRACT

A system and method for coordination between at least two participating vehicles for peer-to-peer trade of the vehicles' positions including a local device on the participating vehicle that measures and transmits at least one output signal; a computing device configured to receive the at least one output signal from the device and display the at least one output signal in real-time; a graphical user interface on the computing device that allows a system administrator to view and customize options for monitoring the at least one output signal; and a hosted server that initiates a peer-to-peer trade of the participating vehicle's position based on determination of a multitude of factors, wherein the local device and the computing device are communicatively connected to each other via a communications network, and wherein the participating vehicle is human-driven, partially-automated, or fully-automated.

### CROSS-REFERENCE TO RELATED APPLICATION

The present application claims priority under 35 U.S.C. §119(e) to U.S. Provisional Patent Application No. 62/275,830, filed on Jan. 7, 2016, entitled “Congestion Pricing Method,” which is hereby incorporated by reference.

### FIELD OF THE DISCLOSURE

The present invention generally relates to a method and system of congestion pricing based on voluntary peer-to-peer exchange of money between occupants of non-automated, partially-automated or fully-automated road vehicles in exchange for ceding priority (right-of way) in a traffic stream.

### BACKGROUND OF THE DISCLOSURE

Congestion pricing on road networks has traditionally been conceived of as a mechanism by which the system operator charges each motorist a fee, which is distinguished from a classical road toll in that it generally varies across time in some way. In exchange for their payment the motorist is granted access to travel where and when the charging is operable. Systems typically involve either charging motorists to travel on a specific corridor (e.g. the State Route 91 tolled lanes in Orange County, Calif.), or a geographic area encompassed by a defined cordon line (e.g. the scheme in Central London, UK). Price may vary temporally according to a pre-defined schedule, or may vary dynamically in response to real-time traffic network conditions.

Congestion pricing is one way of allocating priority through a traffic network to specific vehicles (those that have paid the charge), though in practice other mechanisms are more widely used to provide differential degrees of traffic network priority to specific types of vehicles. Police and other emergency vehicles use sirens and flashing lights to direct that other motorists cede right-of-way (NB: Systems to draw on vehicle-to-vehicle communications to assist with path-clearing for emergency vehicles have been proposed). The use of sirens and lights is not in all cases limited to emergency situations; the motorcade of a government minister may, for instance, legally use sirens and lights to direct other motorists to give way. Vehicle design can also facilitate priority; motorcycles' narrow width enables them, in certain circumstances, to maneuver past standing queues of four-wheel traffic. Physical design is also used to give traffic network priority to certain vehicle types; bus and bicycle lanes are common examples. Tolled road corridors frequently allow vehicles equipped with an electronic tag to bypass toll plazas at which cash-paying motorists must stop. Another example of network priority is the dedication of specific lanes to only permit-carrying traffic, such as, e.g., during the 2012 Olympics in London, where lanes were re-allocated from general vehicular traffic, for the exclusive use of Olympics-related vehicles.

While there is an increasing use of technology to streamline and prioritize certain vehicles over others during emergency or other circumstances, there are still many limitations which unavoidably result in network congestion. For example, existing methods and systems still require active government oversight and involvement, which can be inefficient, slow to respond to changing conditions, politically contentious, and expensive to administer. Furthermore, the existing methods and systems do not allow for real-time, peer-to-peer, private exchange of vehicle positions. An unfulfilled need therefore exists for a means to enable automobiles to exchange positions with one another in a voluntary and efficient manner.

### BRIEF SUMMARY OF THE DISCLOSURE

An aspect of the present disclosure provides a system for coordination between at least two participating vehicles including a local device on the participating vehicle that measures and transmits at least one output signal; a computing device configured to receive the at least one output signal from the device and display the at least one output signal in real-time; and a graphical user interface on the computing device that allows a system administrator to view and customize options for monitoring the at least one output signal, wherein the local device and the computing device are communicatively connected to each other via a communications network.

The system may further include a hosted server that is (i) configured to store and analyze the at least one output signal and (ii) connected to the local device and the computing device via the communications network.

The hosted server may be further configured to (i) determine the participating vehicle's relative valuation of travel time to the participating vehicle's intended destination and compensation; (ii) determine a safe driving pattern and the required set of maneuvers for each participating vehicle; and (iii) determine via communication between the at least two participating vehicles, a mutually beneficial trade wherein a first participating vehicle voluntarily relocates away from its current location and/or trajectory in exchange for compensation from a second participating vehicle.

The at least two participating vehicles' relative valuation of travel time, safe driving pattern, required set of maneuvers, and mutually beneficial trade may be determined by at least one of: a probability algorithm, a machine learning algorithm, or combination thereof. The safe driving pattern may be determined by trajectory planning.

The first participating vehicle that accepts compensation may voluntarily relocate away from its current location and/or trajectory as to provide a right of way to the second participating vehicle that pays such compensation. The compensation may be at least one of: monetary, credit, or combination thereof.

The graphical user interface may be configured to allow a user of the first participating vehicle to (i) set a range of acceptable time delays and/or other disutility for ceding right of way to the second participating vehicle; and/or (ii) manually approve if the time delay falls outside the range of acceptable time delays.

The graphical user interface may be configured to allow a user of the second participating vehicle to (i) set a destination and a desired arrival time to the destination; and/or (ii) set a range of acceptable compensation that the user of the second participating vehicle is willing to pay to the first participating vehicle to arrive at the destination in the desired arrival time or subject to the other disutility.

The other disutility may include, e.g., slowing down the vehicle, speeding up the vehicle, stopping the vehicle on a side of the road, and the like.

The system administrator may include an authorized user of one or more of the at least two participating vehicles, IT administrator, insurance company, emergency call center, police, hospital, and/or fire department.

The at least one output signal may be associated with at least one of: movement of one of the at least two participating vehicles and/or geographic location of the at least two participating vehicles.

The local device may include at least one of: a radar sensor, a lidar sensor, an infrared sensor, an ultrasound sensor, a video camera, a still camera, an input command device, vehicle sensor, a movement sensor, a position sensor, a communications device, a control unit, an image sensor, and/or an audio sensor.

The movement sensor may include at least one of accelerometer, gyroscope, and/or magnetometer.

The position sensor may include at least one of: global positioning system (GPS), GLONASS, BeiDou, Galileo, NAVIC, QZSS, DORIS, geo-satellite service (GSS), cellular location data detector, and/or wireless location triangulation device.

The communications device may include at least one of microwave, Infrared or RF module or a cellular/wireless modem and is configured to transmit the at least one measured output to the computing device. The image sensor may include any RGB, CCD, CMOS or FLIR. The image sensor may be configured to detect and convey an image to the computing device.

The system may be configured to send an action signal to the participating vehicle when it agrees to voluntarily relocate away from its current location and/or trajectory. The action signal may include at least one of: moving the participating vehicle to an another driving lane or position entirely within its current lane or an intermediate position where the participating vehicle is straddling the boundary between two lanes or the boundary between a lane and road shoulder, accelerating, decelerating, applying brakes, turning on brake or head lights, or turn indicators or electronic messaging to indicate such maneuvers, applying a honk, or any combinations thereof.

The audio sensor may include a microphone. The audio sensor may be configured to detect an audio signal from the user of one of the at least two participating vehicles. The audio signal may include an instruction to carry out at least one of the following: initiate, accept, or end trade, change direction or destination of the at least two participating vehicles, or any combination thereof. The audio signal may include a word, a phase, sound signature, and any other preprogrammed sound signal. The system may further be configured to carry out an instruction based on the audio signal.

The local device may be configured to measure the at least one output signal as raw analog data and transmit the raw analog data to the computing device. The computing device may be configured to convert the raw analog data into digital data.

The computing device may be configured to analyze the at least one output signal of the participating vehicle to check for any anomalies for the participating vehicle that are preprogrammed into the system by the emergency response professional, and/or a user. The computing device may be configured to display the at least one output signal to a verified or an authorized user.

The computing device may include a computer readable code that is configured to analyze the at least one output signal of the at least two participating vehicles.

The local device may include an identification unit that is configured to identify the user of the participating vehicle and retrieve the user's information from the hosted server.

The identification unit may be further configured to identify the user based on the user's fingerprint, palm veins, face recognition, DNA, palm print, hand geometry, iris recognition, retina and/or scent.

The system may further include at least one remote device that is communicatively connected to the local device and the computing device. The at least one remote device may include a position sensor which is configured to detect a position of the at least one remote device.

The at least one remote device may include an identification verification unit that is configured to verify that the user of the participating vehicle is also a user of the at least one remote device.

Another aspect of the present disclosure provides a non-transitory computer readable storage medium tangibly embodying a computer readable program code having computer readable instructions which, when implemented, cause a computer to carry out a plurality of method steps including: receiving from a user's participating vehicle the user's destination and a desired arrival time to the destination on a local device; receiving from the user a set of acceptable compensation that the user is willing to pay in order to arrive at the destination in the desired time on the local device; measuring at least one output signal on the local device; and transmitting the at least one output signal, the destination, the desired arrival time, and the set of acceptable compensation to a computing device from the local device; wherein the computing device is configured to execute the steps including: determining the user of the participating vehicle's intended destination, estimated travel time, and valuation of travel time to the destination, determining a safe driving pattern and the required set of maneuvers for each participating vehicle; and determining via communication between the one or more participating vehicles, a mutually beneficial trade wherein one or more of the participating vehicles voluntarily relocate away from their current location and/or trajectory in exchange for compensation from the user's participating vehicle.

In an embodiment of the present disclosure, the method may further include: receiving from a participating vehicle a range of acceptable time delays for ceding right of way to the user's participating vehicle; and receiving a manual approval from a user of the participating vehicle if the time delay falls outside the range of acceptable time delays. The method may further include a hosted server that carries out the steps as disclosed herein.

In an embodiment of the present disclosure, the output signal may include movement of the participating vehicle and/or geographic location of the participating vehicle.

In another aspect of the present disclosure, a non-transitory computer readable storage medium tangibly embodying a computer readable program code having computer readable instructions which, when implemented, cause a computer to carry out a plurality of method steps including: receiving from a user's participating vehicle the user's destination and a level of urgency on a local device; receiving from the user a set of acceptable compensation that the user is willing to pay on the local device; measuring at least one output signal on the local device; and transmitting the at least one output signal, the destination, the desired arrival time, and the set of acceptable compensation to a computing device from the local device; wherein the computing device is configured to execute the steps comprising: determining the user's participating vehicle's intended destination, estimated travel time, and valuation of travel time to the destination, determining a safe driving pattern and the required set of maneuvers for each participating vehicle; and determining via communication between the one or more participating vehicles, a mutually beneficial trade wherein the one or more participating vehicles voluntarily relocate away from their current location and/or trajectory in exchange for compensation from the user's participating vehicle.

### BRIEF DESCRIPTION OF THE SEVERAL VIEWS OF THE DRAWINGS

FIG. 1 shows an example of a system for coordination between one or more participating vehicles that is constructed according to the principles of the disclosure.

FIG. 2 shows an example of a process for coordinating between one or more participating vehicles that is constructed according to the principles of the disclosure.

FIG. 3 shows another example of a process for coordinating between one or more participating vehicles that is constructed according to the principles of the disclosure.

FIG. 4 shows an example of a computer system that may be part of a vehicle system in accordance with the principles of the disclosure.

### DETAILED DESCRIPTION OF THE DISCLOSURE

The disclosure and the various features and advantageous details thereof are explained more fully with reference to the non-limiting implementations and examples that are described and/or illustrated in the accompanying drawings, and detailed in the following description. It should be noted that the features illustrated in the drawings are not necessarily drawn to scale, and features of one implementation may be employed with other implementations, as any person skilled in the art would recognize, even if not explicitly stated herein. Descriptions of well-known components and processing techniques may be omitted so as to not unnecessarily obscure the implementations of the disclosure. The examples used herein are intended merely to facilitate an understanding of ways in which the disclosure may be practiced and to further enable those of skill in the art to practice the implementations of the disclosure. Accordingly, the examples and implementations herein should not be construed as limiting the scope of the disclosure.

Throughout the specification and claims, the following terms take at least the meanings explicitly associated herein, unless the context dictates otherwise. The meanings identified below do not necessarily limit the terms, but merely provide illustrative examples for the terms.

The meaning of “a,” “an,” and “the” may include plural references, and the meaning of “in” may include “in” and “on.” The phrase “in one implementation,” as used herein does not necessarily refer to the same implementation

The term “coupled” means at least either a direct electrical connection between the connected items or an indirect connection through one or more passive or active intermediary devices. The term “circuit” means at least either a single component or a multiplicity of components, either active and/or passive, that are coupled together to provide a desired function. The term “signal” as used herein may include any meanings as may be understood by those of ordinary skill in the art, including at least an electric or magnetic representation of current, voltage, charge, temperature, data or a state of one or more memory locations as expressed on one or more transmission mediums, and generally capable of being transmitted, received, stored, compared, combined or otherwise manipulated in any equivalent manner.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a cloud, a super computer, a personal computer, a laptop computer, a palmtop computer, a mobile device, a tablet computer, a notebook computer, a desktop computer, a workstation computer, a server, or the like, or an array of processors, microprocessors, central processing units, general purpose computers, super computers, personal computers, laptop computers, palmtop computers, mobile devices, tablet computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communications network,” as used in this disclosure, means a wired and/or wireless medium that conveys data or information between at least two points. The wired or wireless medium may include, for example, a metallic conductor link, a radio frequency (RF) communication link, an Infrared (IR) communication link, telecommunications networks, an optical communication link, internet (wireless and wired) or the like, without limitation. The RF communication link may include, for example, WiFi, WiMAX, IEEE 802.11, DECT, 0G, 1G, 2G, 3G, 4G, 5G or future cellular standards, Bluetooth, Bluetooth Low Energy, NFC, ultrasound, induction, laser (or similar optical transmission) and the like.

A “computer-readable storage medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks, flash memory, and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, the cloud network, or the like, or any combination of the foregoing, any of which may be configured to communicate data via a wireless and/or a wired communication medium. These networks may run a variety of protocols not limited to TCP/IP, IRC, SSL, TLS, UDP, or HTTP.

A term “congestion pricing,” as used in this disclosure means, but is not limited to, for example, any form of time-varying pricing for the use of road space. Various forms of congestion pricing are currently used in practice, all of which are based on a centralized architecture in which the prices charged to users are determined by a central management authority, which also collects all revenues. In contrast, this disclosure describes a system in which money or other consideration is exchanged between road users on a peer to peer basis in exchange for priority on the road network.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

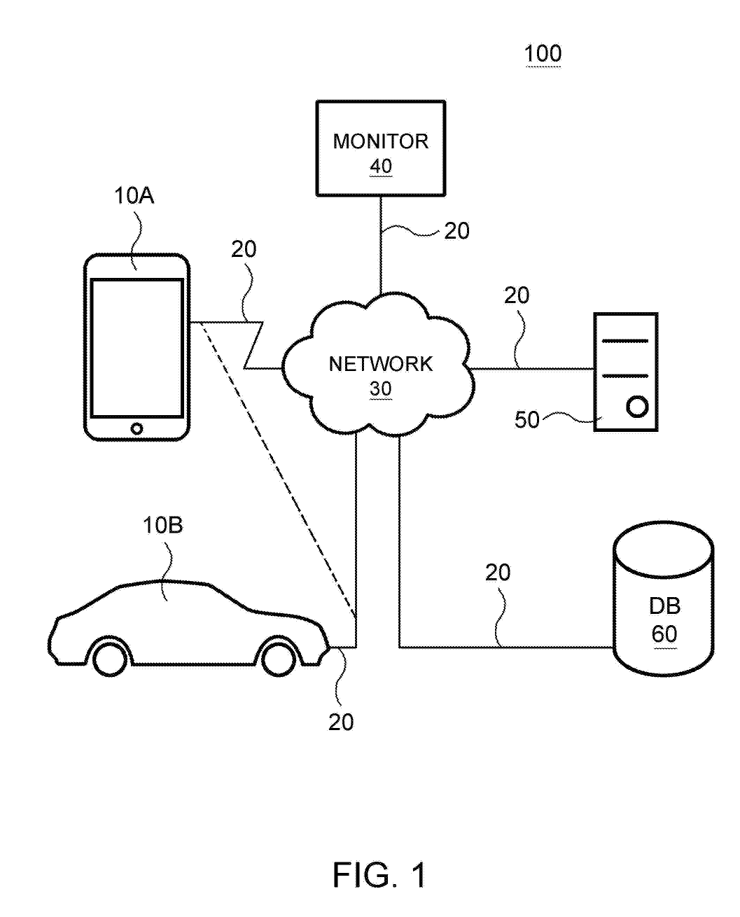

Referring generally to FIGS. 1-4, various implementations of systems, devices, and methods in accordance with the present disclosure may be described herein. Where the various figures may describe implementations sharing various common elements and features with other implementations, similar elements and features are given the same reference numerals and redundant description thereof may be omitted below.

In general, a local device (or a vehicle itself) is configured in accordance with the present disclosure to detect vehicle status, such as, for example, a vehicle location or speed, and provide output signals to local and/or remote devices or indicators representative of vehicle data and vehicle status. The output signal may also include vehicle's inputted destination, desired arrival time to said destination, willingness to pay up to certain monetary (or credit) compensation to another vehicle for right-of-way in order to arrive at said destination within (or as close as possible to) the desired arrival time, and willingness to cede right-of-way to another vehicle for certain monetary compensation. Instead of desired arrival time, a user may input (or select from) at least one of a set of urgency that correspond to a level of acceptable compensation that the user is willing to pay, such as, for example, a hospital visit and a corresponding higher compensation, a grocery run and a corresponding lower compensation, and the like. A host system may include a central server configured to send and receive data to and from the device, and a user interface, such as, for example, a hosted web site generated via the central server or a program application downloaded to and generated from a remote user device such as for example a smartphone, the user interface being optionally configured to display the vehicle data and status received from the local device and/or to receive remote user input for programming the local device. The local device may in various implementations be a dedicated or standalone device for use in (and powered by a power source associated with) a vehicle, such as, for example, a cigarette lighter adapter or a USB plug, or may be a computing device having numerous alternative uses, such as, for example, a smartphone running a dedicated program application.

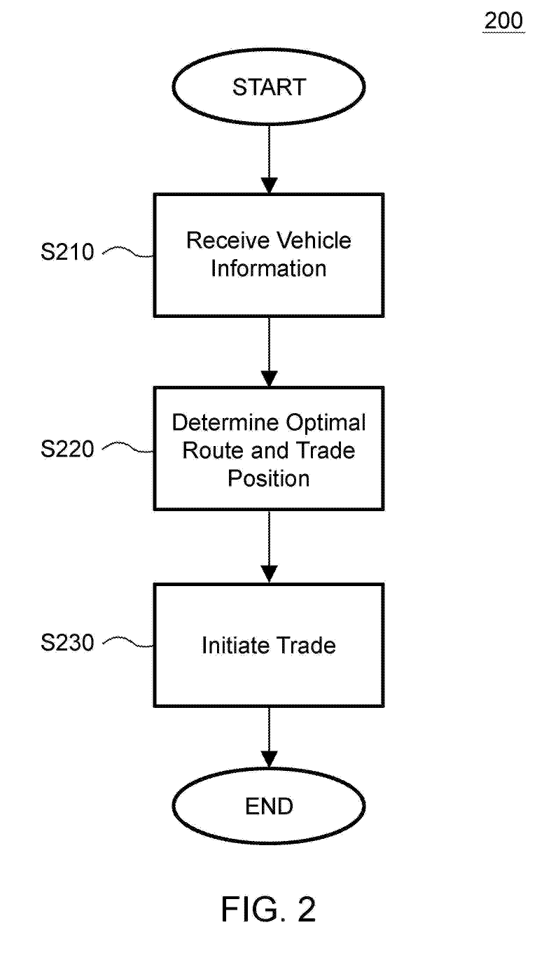

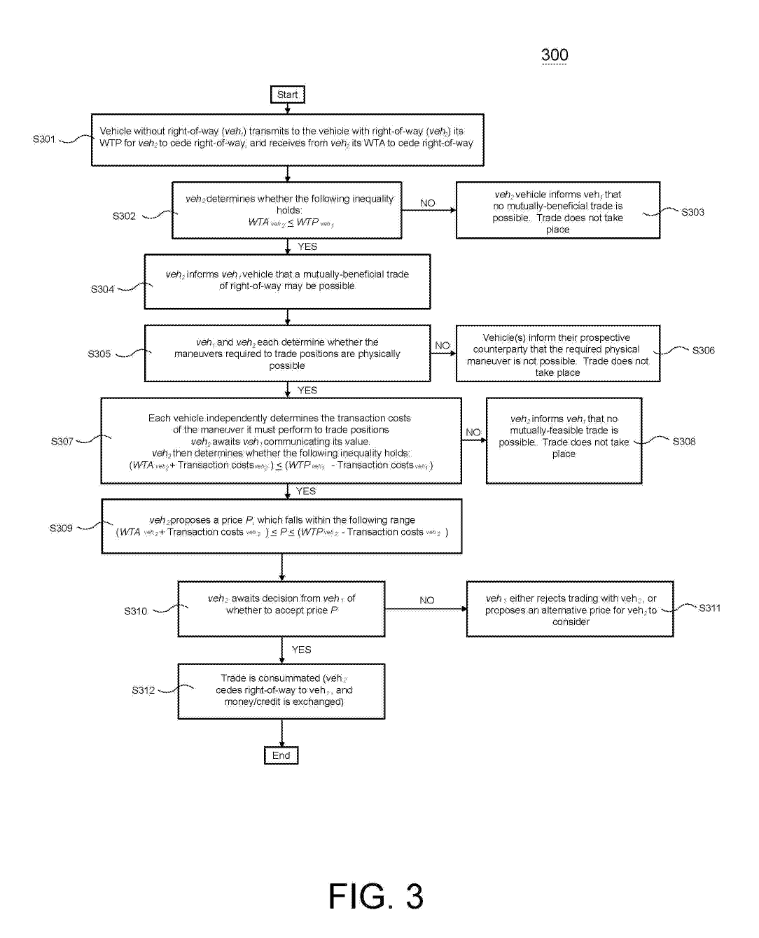

FIG. 1 shows an example of a system 100 constructed according to the principles of the disclosure that provides coordination between one or more participating vehicles (as shown in, e.g., FIGS. 2-3). The system 100 includes at least one participating vehicle 10B, a network 30, a monitor (e.g., a system manager) computer (or computing device) 40, a hosted server (or computer) 50, and a database 60, all of which may be coupled to each other via communication links 20. For instance, the hosted server 50 and database 60 may be connected to each other and/or the network 30 via one or more communication links 20. The at least one participating vehicle 10B and the monitor computer 40 may be coupled to the network 30 via communication links 20. The at least one participating vehicle 10B may be used by, for example, an authorized user (e.g., driver, passenger, or the like) of the at least one participating vehicle, IT administrator, municipality officer, police officer, emergency services responder, or the like.

The system 100 may also include a local device 10A that may be coupled to the at least one participating vehicle 10B, the network 30, the monitor computer 40, the hosted server 50, and the database 60. Alternatively, the local device 10A may be integrated into the at least one participating vehicle 10B.

The local device 10A, the at least one participating vehicle 10B, the monitor computer 40, the hosted server 50, and the database 60 may each include a computer-readable medium including a computer program that may be executed to carry out the processes disclosed herein. The computer-readable medium may include a code section or code segment for performing each step disclosed in, e.g., FIGS. 2-3.

The local device 10A and 10B may each include at least one of the following sensor(s): a radar sensor, a lidar sensor, an infrared sensor, an ultrasound sensor, a camera, an input command device, vehicle sensor, a movement sensor, a position sensor, a communications device, a control unit, an image sensor, and/or an audio sensor. The movement sensor may include at least one of accelerometer, gyroscope, and/or magnetometer. The position sensor may include at least one of: global positioning system (GPS), GLONASS, BeiDou, Galileo, NAVIC, QZSS, DORIS, geo-satellite service (GSS), cellular location data detector, and/or wireless location triangulation device. The communications device may include at least one of RF module or a cellular/wireless modem and is configured to transmit the at least one measured output to the computing device. The image sensor may include any RGB, CCD, CMOS or FLIR. The mage sensor may be configured to detect and convey an image to the monitor computer 40. The local device 10A, at least one remote device (as described below), and the monitor computer 40 may be configured to be connected to an on-board diagnostics (OBD) system of the participating vehicle, or similar car telematics connection system of the vehicle.

The data captured from the above described sensors (or ODB) is then sent to the monitor computer 40 (or the hosted server 50 and the database 60).

The software products residing on the hosted server 50 may be effective to, for example, generate a graphical user interface (not shown) such as a website and associated web pages to display data received from the local device 10A (or the participating vehicle 10B) or receive data from a user (e.g., driver, system administrator, and the like) for programming the local device 10A (or the participating vehicle 10B). Data from the local device 10A or the participating vehicle 10B may further be stored in the database 50 in an account associated with the user of the participating vehicle and used for retrieving the user information, such as, for example, desired destination, payment method, payment history, location history, car model and type, home address, user's name and age, and the like. Such information may be used in processing payment for the mutually beneficial trade.

The data from the local device 10A (or the participating vehicle 10B) may also be used for data trending or other statistical analysis or reporting. The hosted server 50 may further provide software products for downloading via the graphical user interface or by other known transmission media (or via third party servers such as for example conventionally known mobile application markets) to the local device 10A, participating vehicle 10B, or a remote device (not shown) such that upon execution of a host-provided program the user may be able to remotely access data from the local device 10A (or the participating vehicle 10B). The remote device may include any of a number of computing devices, such as, e.g., desktops, laptops, tablets, smart-phones, etc., as operable to download the software products and execute the associated program features as described herein.

Referring to FIGS. 1-2 concurrently, the local device 10A or the participating vehicle 10B may be configured to transmit to the monitor device 40 (or the hosted server 50 and/or the database 60) via network 30 an output signal (Step 210). The output signal may then be transmitted to the other participating vehicles in order to facilitate a mutually beneficial trade between the participating vehicles. The output signal may be automatically (or manually) transmitted based on, e.g., user's option or authorization, proximity of the participating vehicles, or the like.

The output signal may include the user's destination, a desired arrival time to the destination, and a set of acceptable compensation that the user is willing to pay in order to arrive at the destination in the desired time. Alternatively, the output signal may include another user's destination, a range of acceptable time delays for ceding right of way to another participating vehicle, and/or a setting to manually (or automatically) approve a trade of vehicle positions (e.g., ceding the right-of-way to the participating vehicle that provides compensation) if the time delay falls outside the range of acceptable time delays. The output signal may also include movement of associated participating vehicle (e.g., past, current, or intended movement) and/or geographical location of said participating vehicle. Further, the output signal may be configured to be activated once the participating vehicle enters a highway. For example, a user may manually drive the participating vehicle on a local street and activate the process and system for coordinating between one or more other participating vehicles once the participating vehicle enters, e.g., a highway. The participating vehicle may be a partially or completely self-driven vehicle (or manually, i.e. human driven vehicle).

The monitor device 40 (or the hosted server 50 and/or the database 60) may be configured to determine the participating vehicle's intended destination, estimated travel time, and valuation of travel time to the destination, a safe driving pattern and the required set of maneuvers for the participating vehicle; and determine via communication between the two or more participating vehicles, a mutually beneficial trade wherein one or more of the participating vehicles voluntarily relocate away from their current location and/or trajectory in exchange for compensation from the one or more participating vehicles seeking right-of-way (Step 220).

The determination of the mutually beneficial trade may be based on determination (or calculation) of relative valuation of travel time of each participating vehicle's intended destination. The relative valuation may be communicated by the user and may be based on a host of factors, such as, for example, traffic condition, weather condition, intended destination, journey purpose, number of and demographic characteristics of vehicle occupants, emergency situation (e.g., hospital visit), acceptable compensation that the user is willing to pay in order to arrive at the destination in the desired time, and the like. Additional factors may include data captured from the sensor(s) in the local device 10A (or the participating vehicle 10B) described above.

Once (if) the mutually beneficial trade is accepted by a participating vehicle (manually or automatically based on predetermined settings), such participating vehicle may be configured to voluntarily relocate away from its current location and/or trajectory as to provide a right of way to the participating vehicle that pays compensation for right-of-way (Step 230).

Once the mutually beneficial trade is complete (or one or both vehicles have failed to perform their agreed maneuver), the users involved in the trade may provide feedback (e.g., ratings and reviews) on the trade. The feedback may be used by the system to identify users for favorable or unfavorable treatment, up to and including disqualification from future participation in the system and/or reporting to law enforcement. In one embodiment of the present disclosure, the system may, based on users' collective inputs and any data collected during the trade, continually or intermittently update the disclosed system according to prescribed computerized instructions and identify preferred driving pathways (or maneuvers) to achieve a desired result (e.g., faster arrival to desired location, safer or more comfortable maneuvering, and the like) such that the overall experience and efficacy may be improved. There may also be a grace period of time during which the participating vehicle may rescind its participation in an agreed trade, and after which a participating vehicle that rescinds its participation in an agreed trade (in the absence of extenuating external circumstances, such as hazard condition arising unexpectedly) may be identified as having reneged on an agreed trade and/or penalized.

FIG. 3 shows another example of a process for coordinating between one or more participating vehicles that is constructed according to the principles of the disclosure. The congestion pricing method is not limited to this example, and variations on this example are possible. In this example, two vehicles are travelling in the same direction on a road that has a single lane in the direction of travel, and the width of the lane is such that the two vehicles cannot fit abreast (to allow a passing maneuver) unless the leading vehicle (veh₂) moves to occupy the margin of the lane (or straddle the margin of its current lane and the adjacent lane or road shoulder) rather than the center of the lane:
1) The vehicle without right-of-way (veh₁) is initially located behind the vehicle with right-of-way (veh₂). The system as disclosed herein detects the two participating vehicles via, e.g., close proximity, electronic signal, physical signal, or the like, and veh₁ communicates the willingness-to-pay (WTP) value that it is willing to pay if veh₂ allows veh₁ to pass (i.e. cedes right-of-way). veh₂ responds to advise veh₁ whether or not veh₂'s willingness-to-accept (WTA) value is equal to or larger than veh₁'s WTP value. If WTAᵥₑₕ_{₁}>WTPᵥₑₕ_{₁}, then veh₂ determines that no mutually-beneficial transaction is possible at the present time.
2) If, however, WTAᵥₑₕ_{₂}<WTPᵥₑₕ_{₁}, each of the two vehicles then determine whether the maneuver required to trade places in the traffic stream is physically possible, and if so the transaction costs that it would bear to perform the physical maneuver required to swap places. The vehicles then communicate to determine whether the following inequality holds ((WTAᵥₑₕ_{₂}+Transaction costsᵥₑₕ_{₂})>(WTPᵥₑₕ_{₁}−Transaction costsᵥₑₕ_{₁})). If this inequality holds, the vehicles determine that no mutually-beneficial transaction is possible at this time.
3) If, however, (WTAᵥₑₕ_{₂}+Transaction costsᵥₑₕ_{₂})≦(WTPᵥₑₕ_{₁}−Transaction costsᵥₑₕ_{₁}) then the vehicles may communicate to agree on a price P such that (WTAᵥₑₕ_{₂}+Transaction costsᵥₑₕ_{₂}≦P≦(WTPᵥₑₕ_{₁}−Transaction costsᵥₑₕ_{₁}), or a price P may be proposed by the system monitor 40 (or hosted server 50 of FIG. 1).
4) After agreeing on the price of the trade, the trade is then consummated by veh₂ maneuvering to allow veh₁ to safely pass it (i.e. veh₂ cedes the right-of-way to veh₁). The payment of compensation for the trade then takes place via an electronic deposit from the ‘payer’ vehicle (veh₁) to the ‘payee’ vehicle (veh₂). Each of the two vehicles in this example may subsequently provide the monitor 40 (or hosted server 50) with ratings indicating their degree of pleasure or displeasure with the performance of the counterparty vehicle.

### Typical Uses of Invention

### Example of Formular

$$P = ( {WTA}_{{veh}_{2}} + Transaction {costs}_{{veh}_{2}} ) + ( ( {WTP}_{{veh}_{1}} - Transaction {costs}_{{veh}_{1}} ) - ( {WTA}_{{veh}_{2}} + Transaction {costs}_{{veh}_{2}} ) ) * ( {IND}_{{veh}_{2}} / ( {IND}_{{veh}_{2}} + {IND}_{{veh}_{1}} ) ) \\$$

### Example 1

WTA of veh2: no less than $5
WTP of veh1: no more than $8
Transaction costs: assume equal to zero for both vehs
Veh2 ‘indicator’ is 95 ‘merit stars’ (i.e. veh2 is to be treated ‘better’ by the system)
Veh1 ‘indicator’ is 25 ‘merit stars’

P=($5)+(($8)−($5))*(95/(95+25))=($5)+($3)*(0.79)=$7.375

### Example 2

WTA of veh2: $5
WTP of veh1: $8
Transaction costs: assume equal to zero for both vehs
Veh2 ‘indicator’ is 25 ‘merit stars’
Veh1 ‘indicator’ is 95 ‘merit stars’ (i.e. veh1 is to be treated ‘better’ by the system)

P=($5)(($8)($5))*(25/(95+25))=($5)+($3)*(0.21)=$5.625

In yet another embodiment of the present disclosure, a participating vehicle that is in close proximity with the other participating vehicle(s) may automatically (or manually) turn on the disclosed system or process upon detection of the proximity via, e.g., bluetooth, GPS sensor motion sensor, or other electronic or physical sensors. The participating vehicles may then set a willingness to pay in graphic user interface of, e.g., the local device 10A, the participating vehicle 10B, the monitor computer 40 of FIG. 1. Alternatively, the system may retrieve a particular user of the participating vehicle's willingness to pay from the database 60 where such information along with other information, such as, payment method (e.g., credit card, bank information, and the like), may be stored. The participating vehicles may indicate on their respective graphic user interfaces their willingness to accept consideration for ceding the right-of-way. Similarly, the participating vehicles may indicate on their graphic user interfaces the willingness to pay up to a certain amount of consideration for obtaining a right-of-way from other participating vehicles. Then, the system may compares the willingness to pay/accept between the participating vehicles as disclosed in, e.g., FIG. 3, and executes the mutually beneficial trade for the participating vehicle's right-of-way. Once the system automatically (or manually by the user based on system settings) authorizes the deposit, the server may send instructions (or action signals) to the participating vehicles to initiate an action, such as, for example, pass maneuvering.

Referring to FIGS. 1-4 concurrently, an illustrative embodiment of a computing system 400 that may be used as an apparatus within a vehicle system for implementing any one or more of the methods, features, and processes discussed herein, is shown and designated by the computing system 400. The computing system may be an embodiment of a system included on the local device 10A, the participating vehicle 10B, the monitor computer 40, the remote device (not shown), the hosted server 50, or the database 60.

The computing system 400 may include a processing unit 410 comprised of a processor 411 in communication with a main memory 412, wherein the main memory 412 may store a set of instructions 427 that may be executed by the processor 411 to cause the computing system 400 to perform any one or more of the methods, processes or computer-based functions disclosed herein. For example, the mutually beneficial trade method and system described throughout this disclosure may be a program that is comprised of the set of instructions 427 that are executed to perform any one or more of the methods, processes or computer-based functions described herein such as the processes for determining whether to initiate a mutually beneficial trade of vehicle positions, facilitating communication between participating vehicles, and implementing a trade process (including automatically moving the participating vehicles) as described with reference to FIGS. 1-3. The computing system 400 may be integrated into the participating vehicles' own operating system or computing system. The computing system 400 may also be connected using a network such as network 30 illustrated in FIG. 1, to communicate with other participating vehicles, computer systems or peripheral devices (e.g., local device 10A, remote device, monitoring computer 40 and the like).

In a networked deployment, the computing system 400 may operate in the capacity of a server or as a client user computer within the vehicle system in a server-client user network environment, or as a peer computer system within a vehicle in a peer-to-peer (or distributed) network environment. Further, while a single computing system 400 is illustrated, the term “system” shall also be taken to include any collection of systems or sub-systems that individually or jointly execute a set, or multiple sets, of instructions to perform one or more computer functions.

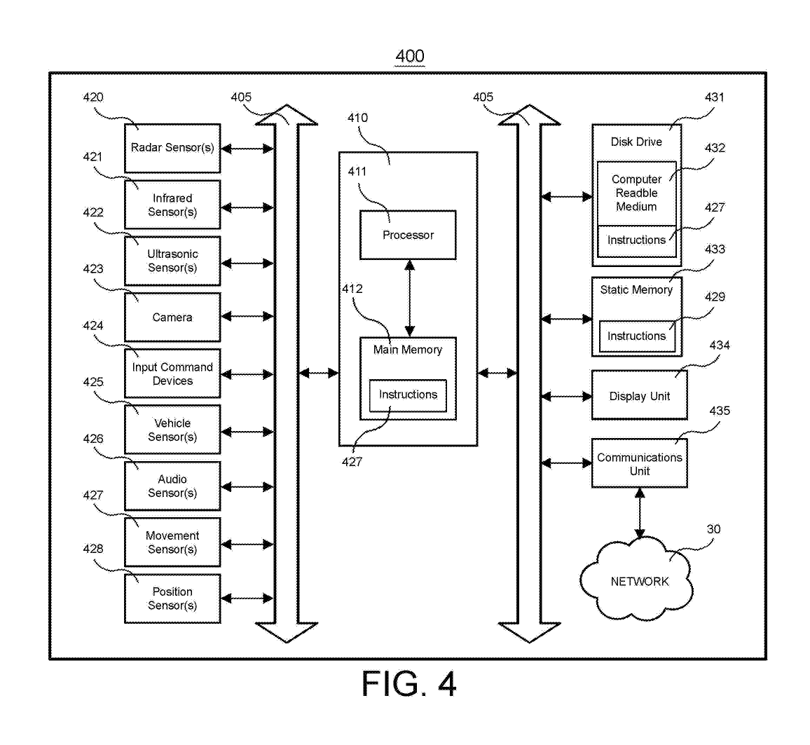

As illustrated in FIG. 4, the computing system 400 may include the processor 411, such as a central processing unit (“CPU”), although the processor 411 may be representative of one or more processing units. Moreover, the computing system 400 may include the main memory 412 and a static memory 433 that can communicate with each other via a bus 405. As shown, the computing system 400 may further include a display unit 434, such as a liquid crystal display (“LCD”), an organic light emitting diode (“OLED”), a flat panel display, a solid state display, or a cathode ray tube (“CRT”). The display unit 434 may correspond to a display component of a display component of a local device 10A, participating vehicle 10B, or monitor computer 40 of FIG. 1. The display unit 434 may further correspond to a display component of a navigation system, vehicle infotainment system, a heads-up display, or instrument panel of the vehicle described herein. Additionally, the computing system 400 may include one or more input command devices 424 for allowing a user, a driver, a passenger, or a system administrator of the vehicle to control the mutually beneficial trade process described herein. The input command devices may include, e.g., a control knob, instrument panel, keyboard, scanner, touch screen or audio input device (e.g., cabin microphone), a remote device (e.g., smartphone, tablet, computer, or the like) that is communicatively connected to the system via a communications link 20 of FIG. 1, buttons, a mouse or touchpad.

The computing system 400 may further include system input components that include, but are not limited to, radar sensor(s) 420, infrared sensor(s) 421, ultrasonic sensor(s) 422, camera 423 (e.g., capable of capturing digital still images, streaming video, and digital video during the mutually beneficial trade in order to facilitate safer and efficient maneuver of participating vehicle), vehicle sensor(s) 425 (e.g., OBD, temperature sensors, fluid level sensors, vehicle speed detection sensors, etc., to check vehicle condition before, during, or after the mutually beneficial trade), audio sensor(s) to receive passive and/or active input (e.g., command) directly from an authorized user (e.g., driver, passenger, or the like) of the participating vehicle in order to facilitate the mutually beneficial trade (e.g., accept or deny trade, initiate trade, change destination, change acceptable compensation for giving up right-of-way, change a desired arrival time to the destination, or the like), movement sensor(s) 427 (e.g., accelerometer, gyroscope, and/or magnetometer to measure the participating vehicle position), position sensor(s) 428 (e.g., global positioning system (GPS), GLONASS, BeiDou, Galileo, NAVIC, QZSS, DORIS, geo-satellite service (GSS), cellular location data detector, and/or wireless location triangulation device) to measure the position of the participating device for purposes of facilitating mutually beneficial trade and/or calculate time and preferred route to the desired destination of the participating vehicle The passive and/or active input may include a feature where the audio sensor is actively or constantly listening to sound in and around the participating vehicle and autonomously (or manually) adjust the disclosed system and process pursuant to the real-time voice command or other audio signals (e.g., slowing down due to sound associated with an accident, emergency vehicle signal, and the like).

The computing device (monitor computer) 40 (or remote device) may receive information inputs from one or more of these system input components. The input components may be in communication with the processing unit 410 via the communications bus 805 (or network 30).

The computing system 400 may also include a disk drive unit 431 for receiving a computer readable medium 432. In a particular embodiment, the disk drive unit 431 may receive the computer-readable medium 432 in which one or more sets of instructions 427, such as the software corresponding to the mutually beneficial trade, can be embedded. Further, the instructions 827 may embody one or more of the methods or logic as described herein. In a particular embodiment, the instructions 427 may reside completely, or at least partially, within any one or more of the main memory 412, the static memory 433, computer readable medium 432, and/or within the processor 411 during execution of the instructions 427 by the processor 411.

The computing system 400 may further include a communications interface 435. The communications interface 435 may be comprised of a network interface (either wired or wireless) for communication with an external network 440 as shown in, e.g., FIG. 1. The external network 440 may be a collection of one or more networks, including standards-based networks (e.g., 2G, 3G, 4G, Universal Mobile Telecommunications System (UMTS), GSM® Association, Long Term Evolution (LTE)™, or more), WiMAX, Bluetooth, near field communication (NFC), WiFi (including 802.11 a/b/g/n/ac or others), WiGig, Global Positioning System (GPS) networks, other telecommunications networks and others available at the time of the filing of this application or that may be developed in the future. Further, the network 440 may be a public network, such as the Internet, a private network, such as an intranet, or combinations thereof, and may utilize a variety of networking protocols now available or later developed including, but not limited to TCP/IP based networking protocols. The network 440 may also be embodied as the network 30 described with reference to FIG. 1.

While the disclosure has been described in terms of exemplary implementations, those skilled in the art will recognize that the disclosure can be practiced with modifications in the spirit and scope of the appended claims. These examples are merely illustrative and are not meant to be an exhaustive list of all possible designs, implementations, applications or modifications of the disclosure.

What is claimed is:

1. A system for coordination between at least two participating vehicles comprising:
a local device on the participating vehicle that measures and transmits at least one output signal;
a computing device configured to receive the at least one output signal from the device and display the at least one output signal in real-time; and
a graphical user interface on the computing device that allows a user to view and customize options for monitoring the at least one output signal,
wherein the local device and the computing device are communicatively connected to each other via a communications network.

2. The system of claim 1, wherein the system further comprises a hosted server that is (i) configured to store and analyze the at least one output signal and (ii) connected to the local device and the computing device via the communications network.

3. The system of claim 2, wherein the hosted server is further configured to (i) determine the participating vehicle's relative valuation of travel time to the participating vehicle's intended destination and compensation; (ii) determine a safe driving pattern and the required set of maneuvers for each participating vehicle; and (iii) determine via communication between the at least two participating vehicles, a mutually beneficial trade wherein a first participating vehicle voluntarily relocate away from their current location and/or trajectory in exchange for compensation from a second participating vehicle.

4. The system of claim 3, wherein the at least two participating vehicles' relative valuation of travel time, safe driving pattern, required set of maneuvers, and mutually beneficial trade are determined by at least one of: probability algorithm, machine learning algorithm, or combination thereof.

5. The system of claim 4, wherein the safe driving pattern is determined by trajectory planning.

6. The system of claim 3, wherein the first participating vehicle that accepts compensation voluntarily relocates away from its current location and/or trajectory as to provide a right of way to the second participating vehicle that pays such compensation.

7. The system of claim 3, wherein the compensation is at least one of: monetary, credit, or combination thereof.

8. The system of claim 3, wherein the graphical user interface is configured to allow a user of the first participating vehicle to (i) set a range of acceptable time delays and/or other indicator of disutility for ceding right of way to the second participating vehicle; and/or (ii) manually approve if the time delay falls outside the range of acceptable time delays and/or the other indicator of disutility.

9. The system of claim 3, wherein the graphical user interface is configured to allow a user of the second participating vehicle to (i) set a destination and a desired arrival time to the destination; and/or (ii) set a range of acceptable compensation that the user of the second participating vehicle is willing to pay to the first participating vehicle to arrive at the destination in the desired arrival time.

10. The system of claim 1, wherein the user comprises an authorized user of the participating vehicle, IT administrator, system administrator, insurance company, emergency call center, police, hospital, and/or fire department.

11. The system of claim 1, wherein the at least one output signal is associated with at least one of: movement of the participating vehicle and/or geographic location of the participating vehicle.

12. The system of claim 1, wherein the local device comprises at least one of: a radar sensor, a lidar sensor, an infrared sensor, an ultrasound sensor, a video camera, a still camera, an input command device, vehicle sensor, a movement sensor, a position sensor, a communications device, a control unit, an image sensor, and/or an audio sensor.

13. The system of claim 12, wherein the movement sensor comprises at least one of accelerometer, gyroscope, and/or magnetometer.

14. The system of claim 12, wherein the position sensor comprises at least one of: global positioning system (GPS), GLONASS, BeiDou, Galileo, NAVIC, QZSS, DORIS, geo-satellite service (GSS), cellular location data detector, and/or wireless location triangulation device.

15. The system of claim 12, wherein the communications device comprises at least one of RF module or a cellular/wireless modem and is configured to transmit the at least one measured output to the computing device.

16. The system of claim 12, wherein the image sensor comprises any RGB, CCD, CMOS or FLIR.

17. The system of claim 12, wherein the image sensor is configured to detect and convey an image to the computing device.

18. The system of claim 3, wherein the system is configured to send an action signal to the at least two participating vehicles when at least one of the at least two participating vehicles voluntarily relocate away from their current location and/or trajectory.

19. The system of claim 18, wherein the action signal comprises at least one of: moving the participating vehicle to an another driving lane or position entirely within its current lane or an intermediate position where the first participating vehicle is straddling the boundary between two lanes or the boundary between a lane and road shoulder, accelerating, decelerating, applying brakes, turning on brake or head lights, or turn indicators or electronic messaging to indicate such maneuvers, applying a honk, or any combinations thereof.

20. The system of claim 12, wherein the audio sensor comprises a microphone.

21. The system of claim 12, wherein the audio sensor is configured to detect an audio signal from the user of the at least two participating vehicles.

22. The system of claim 21, wherein the audio signal comprises an instruction to carry out at least one of the following: initiate, accept, or end trade, change direction or destination of the at least two participating vehicles, or any combination thereof.

23. The system of claim 21, wherein the audio signal comprises a word, a phrase, sound signature, and any other preprogrammed sound signal.

24. The system of claim 21, wherein the system is configured to carry out an instruction based on the audio signal.

25. The system of claim 1, wherein the local device is configured to measure the at least one output signal as raw analog data and transmit the raw analog data to the computing device.

26. The system of claim 25, wherein the computing device is configured to convert the raw analog data into digital data.

27. The system of claim 1, wherein the computing device is configured to analyze the at least one output signal of the participating vehicle to check for any anomalies for the participating vehicle that are preprogrammed into the system by the emergency response professional, and/or the user.

28. The system of claim 1, wherein the computing device is configured to display the at least one output signal to the user.

29. The system of claim 1, wherein the computing device comprises a computer readable code that is configured to analyze the at least one output signal of the participating vehicle.

30. The system of claim 1, wherein the local device comprises an identification unit that is configured to identify the user of the participating vehicle and retrieve the user's information from the hosted server.

31. The system of claim 30, wherein the identification unit is further configured to identify the user based on the user's fingerprint, palm veins, face recognition, DNA, palm print, hand geometry, iris recognition, retina and/or scent.

32. The system of claim 1, further comprising at least one remote device that is communicatively connected to the local device and the computing device.

33. The system of claim 32, wherein the at least one remote device comprises a position sensor which is configured to detect a position of the at least one remote device.

34. The system of claim 32, wherein the at least one remote device comprises an identification verification unit that is configured to verify that the user of the participating vehicle is also a user of the at least one remote device.

35. A non-transitory computer readable storage medium tangibly embodying a computer readable program code having computer readable instructions which, when implemented, cause a computer to carry out a plurality of method steps comprising:
receiving from a user's participating vehicle the user's destination and a desired arrival time to the destination on a local device;
receiving from the user a set of acceptable compensation that the user is willing to pay in order to arrive at the destination in the desired time on the local device;
measuring at least one output signal on the local device; and
transmitting the at least one output signal, the destination, the desired arrival time, and the set of acceptable compensation to a computing device from the local device;
wherein the computing device is configured to execute the steps comprising:
determining the user's participating vehicle's intended destination, estimated travel time, and valuation of travel time to the destination,
determining a safe driving pattern and the required set of maneuvers for each participating vehicle; and
determining via communication between the one or more participating vehicles, a mutually beneficial trade wherein the participating vehicles voluntarily relocate away from their current location and/or trajectory in exchange for compensation from the user's participating vehicle.

36. The method of claim 35, further comprising:
receiving from a participating vehicle a range of acceptable time delays for ceding right of way to the user's participating vehicle; and
receiving a manual approval from a user of the participating vehicle if the time delay falls outside the range of acceptable time delays.

37. The method of claim 35, further comprising a hosted server that carries out the steps of claim 35.

38. The method of claim 35, wherein the output signal comprises movement of the participating vehicle and/or geographic location of the participating vehicle.

39. A non-transitory computer readable storage medium tangibly embodying a computer readable program code having computer readable instructions which, when implemented, cause a computer to carry out a plurality of method steps comprising:
receiving from a user's participating vehicle the user's destination and a level of urgency on a local device;
receiving from the user a set of acceptable compensation that the user is willing to pay on the local device;
measuring at least one output signal on the local device; and
transmitting the at least one output signal, the destination, the desired arrival time, and the set of acceptable compensation to a computing device from the local device;
wherein the computing device is configured to execute the steps comprising:
determining the user's participating vehicle's intended destination, estimated travel time, and valuation of travel time to the destination,
determining a safe driving pattern and the required set of maneuvers for each participating vehicle; and
determining via communication between the one or more participating vehicles, a mutually beneficial trade wherein the one or more participating vehicles voluntarily relocate away from their current location and/or trajectory in exchange for compensation from the user's participating vehicle.
